(19) United States
(12) Patent Application Publication
(10) Pub. No.: US 2005/0083789 A1
(43) Pub. Date: Apr. 21, 2005

(54) Watch with independent modules

(76) Inventor: Avi Matatov, New York, NY (US)

Correspondence Address: Stephen E. Feldman, P.C., 12 East 41st Street, New York, NY, 10017, US

(21) Appl. No.: 10/688,730

(22) Filed: Oct. 16, 2003

(51) Int. Cl. G04B 29/00; G04B 37/00

(52) U.S. Cl. 368/300

(57) ABSTRACT

A watch mechanism comprising a plurality of movements. Each movement has a face and each movement is capable of operating independently of each other movement. Each movement being capable of being removed from the watch independently of each other movement and each movement being capable of operation following the removal of one or more other movements.

### FIELD

This invention relates generally to watches and time pieces.

### BACKGROUND

In this day and age, a large number of businesses and businessmen operate their companies and business entities on an international basis, and therefore many individuals have the need to have international times at their instant disposal. Therefore, there is a general need for watches which display not only the wearer's local time, but also various other national and international time zone times. However, in the case of multiple time zone watches, there is usually a main dial which takes up the entire face of the watch and furthermore takes up most of the internal space for its movement.

Typically in watching having more than one movement, the internal mechanisms of the different dials are either inside the movement of the main watch or are linked to the main watch movement. This typical positioning leads to difficulty in reading the watch because the main dial has the smaller dials inside of it, thereby causing visual confusion to the watch wearer.

Additionally, the internal mechanism of the smaller dials are either inside the mechanism of the main watch or are linked mechanically to the main watch. In linking the watch mechanisms together, they are inherently dependent on each other so that if one dial mechanism fails, all the other three watch mechanisms will fail also. Therefore, in servicing one of the mechanisms, all of the watch mechanisms have to be serviced simultaneously.

U.S. Pat. No. 2,361,563 to Pellaton discloses a watch having multiple dials. Pellaton discloses a principal dial and a series of smaller dials, where the principle dial takes up the entire face of the watch, and the smaller dials are located in subsections of the later dial. Each dial is operationally dependent upon each other dial.

U.S. Pat. Des 327,443 and 327,656 to Sugita et al. each disclose an ornamental design for a watch face. Each patent discloses the watch face having three analogue dials and one digital dial. In the '443 patent, the analogue dials are located at approximately the nine o'clock, twelve o'clock and three o'clock positions. The digital dial appears as a one hundred and twenty degree segment of a pie, where the center of the pie is located at the center of the watch face, and the remainder of pie section is distributed along the bottom edge of the watch face.

Turning to the '656 patent, the analogue dials are located at approximately the three o'clock, the six o'clock and the nine o'clock positions. The digital dial appears as a one hundred and eighty degree segment of a pie, where the center of the pie is above the center of the watch face, and the remainder of the pie section is distributed along the top edge of the watch face.

U.S. Pat. Des. 465,739 to Arabov discloses an ornamental design for a watch face. The watch face has multiple analogue, including a principle dial and four smaller dials. The principal dial takes up the majority of the watch face, with the four smaller dials are located on the periphery of the watch face, at the two o'clock, four o'clock, eight o'clock and ten o'clock positions, respectively. The smaller faces are each the same size and partially overlap the main watch face.

U.S. Pat. No. 5,043,955 to Dubois teaches a watch face parsed into four analogue displays on a four quadrant grid. Each display accounts for one quarter of a twelve hour period, where the upper right quadrant accounts for the time between twelve and three (AM or PM), the lower right quadrant accounts for the hours between three and six, the lower left quadrant accounts for the hours between six and nine, and the upper left quadrant accounts for the hours between nine and twelve. Each display is only active for three hours at a time and is only activated following the completing of three hour period in the previous quadrant. In an alternative embodiment, a center hand displays the hour and each quadrant sequentially displays one quarter of an hour.

None of this prior art, however, provides for a multiple dial watch with the multiple dials operating with independent dial mechanisms. Furthermore, none of these previous patents provides a multiple-dial watch which is easily read through the use of one principal and independent dial and various smaller, operationally independent dials. The present invention addresses the problems inherent in these prior patents through the creation of a watch which is easily read and in which the multiple dials are all independent of the other dials, thus providing for easy repair and the elimination of confusion while the wearer is reading the watch.

In the present invention, the mechanisms are separate and independent of each other and therefore if one mechanism fails, another mechanism can be reset and used as the main watch until the broken mechanism is repaired. The failed mechanism can be removed and serviced, or replaced without the extraordinary costs of fixing all four dials, when they are controlled by a single mechanism. This four dial watch has one dial that is larger, with the other three dials smaller. The larger dial is usually set with the local time, allowing the wearer to avoid time delay and confusion in attempting to read the local time, with numerous watch dials.

### SUMMARY

The present invention provides a four conventional time-piece movement watch having four separate watch dials with a principal dial and three smaller dials, each dial displaying a different time. There are four time-piece movements which drive the hour-hands, the minute-hands and the second-hands. The principal dial is the largest, most prominent dial and is positioned to be the closest dial to the user of the watch, when the watch is worn on the wrist. The principal dial is the largest, most visible dial, allowing the wearer to determine the time in his own time zone quickly, without confusion and without having to determine which dial tells the local time on every occasion that the wearer looks at the watch.

Furthermore, the largest dial's mechanism is independent and separate from those of the three other dials, thereby providing for four independent watch mechanisms. This independence and differences in dial size helps to avoid confusion, to avoid interlocking movements and to prevent the four dials from being operationally dependent on each other. Each of the dials has individual watch movements and therefore are all capable of keeping different times for various time zones. This four movement watch provides the wearer with the ability to read four different times with one watch, while also allowing the wearer to distinguish his local time from the other set times easily and without confusion.

### BRIEF DESCRIPTION OF THE FIGURES

In order that the manner in which the above recited objectives are realized, a particular description of the invention will be rendered by reference to specific embodiments thereof that are illustrated in the appended drawings. Understanding that the drawings depict only typical embodiments of the invention and are not therefore to be considered to be limiting of its scope, the invention will be described and explained with additional specificity and detail through the use of the accompanying drawings in which:

FIG. 1 shows the appearance and overall view of the watch of this invention.

FIG. 2 is a view of the watch, with the face removed.

FIG. 3 is a side view of the outside appearance of the watch.

FIG. 4 is a view of the inside of the watch with the back plate removed to show the location of the various watch modules.

FIG. 5 is a view of an intermediate plate.

FIG. 6 shows a modular unit being removed.

### DESCRIPTION OF THE EMBODIMENTS

A watch mechanism is disclosed having a plurality of movements. Each movement is capable of operating independently of each other movement. Each movement is capable of being removed from the watch independently of each other movement. Each movement is capable of operation following the removal of one or more other movements.

Turning to FIG. 1, a watch 1 is shown having a four dials, including a principal dial 2 and three subordinate dials 4, 6, and 8. Each dial 2, 4, 6 and 8 is placed within the watch 1 so that each dial 2, 4, 6 and 8 is capable of independent operation and capable of being removed from the watch 1 without effecting any other dial 2, 4, 6 or 8.

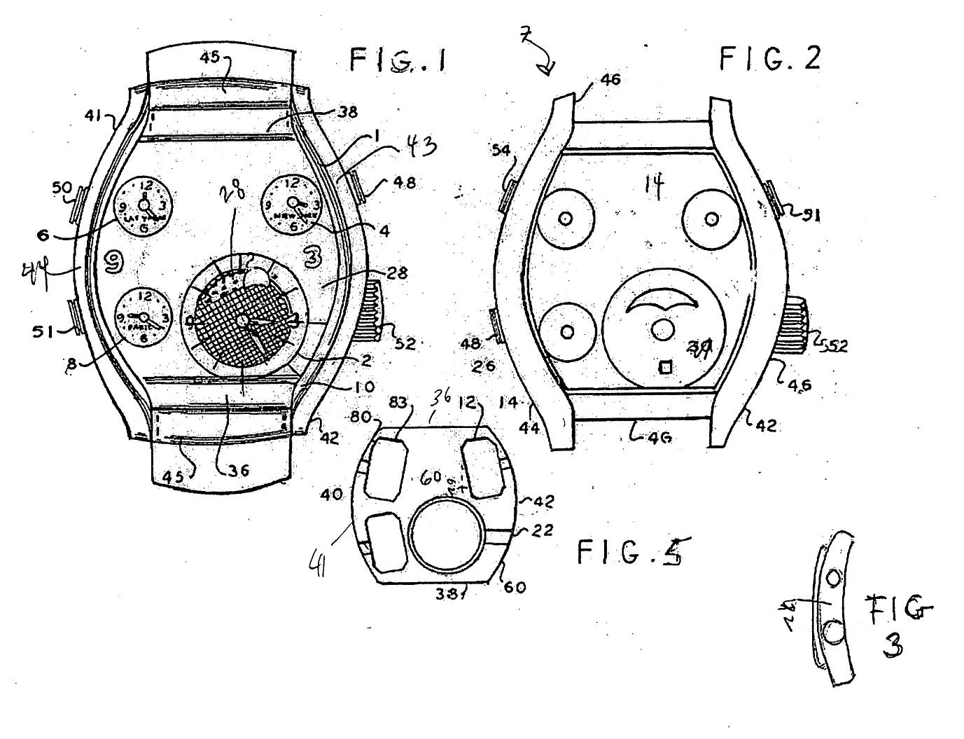

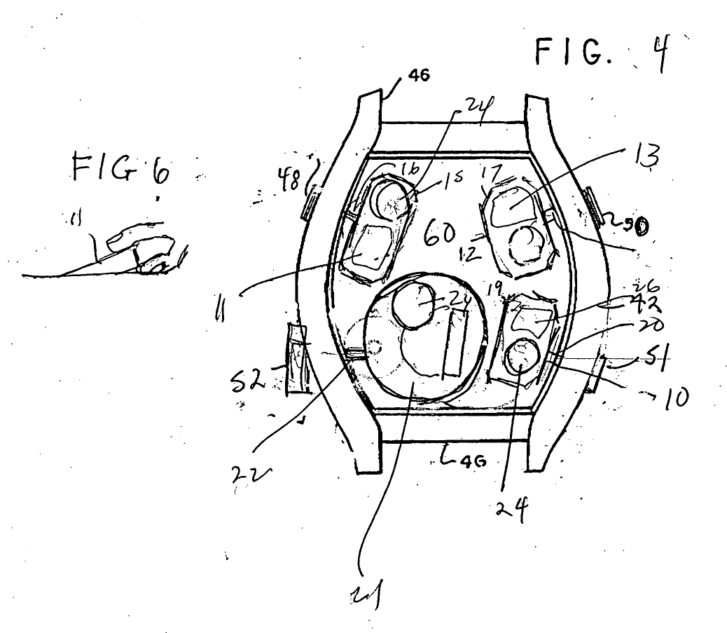

Turning to FIGS. 2 and 3, the watch has a casing 7. The casing 7 is fabricated from a material suitable for withstanding the normal forces and stresses placed on a watch casing. For example, the casing 7 is fabricated from stainless steel. The casing 7 has a top crystal 9. The top crystal 9 is fabricated from a crystal suitable for allowing clear view of the watch dials and for resisting scratching and fracturing during normal use.

The casing 7 has a first and second rounded sides 41 and 42. The rounded sides 41 and 42 have equal and opposing curves. The sides are separated by a distance and has a radial curvature that allows the placement of the dials 2, 4, 6 and 8 within the watch 1. The casing 7 has a cross sectional curve 72, as seen in FIG. 3. The curve 72 allows for the comfortable placement of the watch 72 on the wrist of a user.

The watch casing 7 has a first and second flat sides 36 and 38. The flat sides 36 and 38 are parallel to each other and separated by a distance that allows for the placement of the dials 2, 4, 6, and 8 on the watch. The length of each side 36 and 38 is less than the length required for housing the dials 2, 4, 6 and 8 because of the width supplied through the round edges 41 and 42 on the casing 7.

Turning to FIG. 2, the case edges 41 and 42 each have two rounded members 43 and 44. The rounded members have an curve inflection that opposes the curve of edges 41 and 42. The rounded members are required to flare the ends of the watch face for connecting the watch 1 to a watch band or strap (not shown).

Turning to FIG. 5, the casing 7 has an intermediate plate 60. The plate 60 has a surface area and cross sectional area that is shaped to fit within the casing 7. The plate has four openings 61, 63, 65, and 67, each capable of frictionally engaging the mechanisms and gear stems required to operate each respective dial 2, 4, 6 and 8.

The frictional engagement secures the mechanisms when the bottom plate of the casing is removed to, for example, change a battery or fix the watch. The snap mechanisms or fasteners, such as screws or clips, are alternatively used to hold the mechanisms in openings 61, 63, 65 or 67.

In use, the mechanisms for the dials 2, 4, 6 and 8 are removed from the plate 60 by using a typical jeweler's tool. The plate 60 is made of a rigid material suitable for housing and protecting delicate watch components. For example, the plate 60 is fabricated form stainless steel or a carbon alloy of steel.

Remaining with FIG. 2, the casing of the watch comprises a base plate 14. The base plate is designed to fit against the intermediate plate 60 for holding the watch mechanisms within the intermediate plate 60. For example, the base plate 14 is round. A frictional engagement exists between the base plate 14 and the case 7, and the plate 14 is removed from the case 7 with a standard jeweler's tool. The base plate 14 is manufactured from a rigid material that is comfortable against the skin of a person. For example, the base plate 14 is stainless steel.

Turning to FIGS. 1 and 6, the watch 1 has a first gear mechanism, or movement 15. The first movement 15 is located in the bottom right corner of the watch casing 7. The movement 15 frictionally fits within the opening 61 of the intermediate plate 60. All of the parts required to maintain the operation of the movement 15 are contained within the movement, so that the movement is modular. For example, a gear mechanism required to operate an hour hand, a second hand and a minute hand are all contained within the first movement 15.

A dedicated power source, such as a battery 24, is housed within the movement 15. The battery may changed without removing the movement. Alternatively, a single power source for the each mechanism in the watch is housed in the casing 7.

The dial 2 that encloses the face of the movement 15 is round. The dial has a diameter that is at least half of the length of either flat side 36 or 38. The diameter of the dial 2 is not more than three quarters of the length of either flat side 36 and 38. Preferably the diameter of the dial 2 is two thirds of the length of either flat side 36 or 38. On the other hand, the gear box for the movement 15 is round and is approximately the same size as the dial 2.

Remaining with FIGS. 2 and 5, a second modular movement 16, a third modular movement 17 and a fourth modular movement 18 are located in the watch 1. The movements 16, 17 and 18 are frictionally held inside intermediate plate openings 63, 65 and 67. All of the parts required to maintain the operation of the dials 4, 6 and are contained within each movement 16, 17 and 18, so that the movements are modular. The modules 16, 17 and 18 are generally rectangular in shape with cut-off corners. The length of the modules 16, 17 and 18 is between about twice the width and about three quarters of the diameter of the movement 15. Each module is placed at an angle to the watch face that mimics the curve of the watch edges 41 and 42. Alternatively, the module 16, 17 and 18 are round.

Each of the modules has an independent extending stem, so that the separate dials can be separately set. The angle imposed on the modules 16, 17 and 18 allows the stem of each module to perpendicularly extend from the respective module and perpendicularly protrude from the watch edge 41 and 42. The protrusion angle of the stem minimizes the stress on the stem when a user rotates the stem upon adjusting the watch.

Each of the dials 4, 6, and 8 are respectively located at the upper right, the upper left, and the lower left corner of the watch 1. The dials are located so that a first horizontal line through the watch passes through the centerline of dials 4 and 6. Further, a second horizontal line through the watch passes through the centerline of dials 2 and 8. On the other hand, a vertical line through the watch passes through the centerline of dials 6 and 8.

The diameter of each dial 4, 6 and 8 is the same. The diameters of each dial 4, 6 and 8 is smaller, by approximately half, than the diameter of dial 2. The difference in size and location between the dials defines the main dial 2 and the subordinate dials 4, 6 and 8. For example, the main dial 2 is on the lower right corner of the watch 1 because that is the corner most quickly viewable by a user.

Each movement 15, 16, 17 and 18 has a respective crown 52, 51, 50 and 48 at the end of the respective stem. The crown 52 of the movement 15 is larger than the crowns 51, 50 and 48 of the remaining movements. The remaining crowns 51, 50 and 48 are the same size as each other. The difference in sizes helps emphasis the difference between the main dial 2 and the subordinate dials 4, 6 and 8.

In use, the main dial 2 contains the time most relevant to the watch wearer while the subordinate dials 4, 6 and 8 each contain a time that is less important but still of interest to the wearer. For example, a New York resident would keep the Eastern Standard time in the main dial, but keep central time, pacific time, and Greenwich mean time on dials 4, 6 and 8.

The main dial 2 contains additional functions such as a lunar reference 28. The additional functions further differentiate the main dial 2 from the subordinate dials 4, 6 and 8. The lunar reference is, for example, a rotating picture of phases of the moon 28. The main dial 2 alternatively includes one or more of a lunar reference, a stop watch, and a chronograph.

In use, the modules enable the watch to be readily serviced or repaired by removing a single non-working module 15, 16, 17 or 18. Along with the modules, the respective dial 2, 4, 6 or 8 are removed. On one use, the main dial is removed for repair and not immediately replaced. In this case, a subordinate dial temporarily becomes a main dial. Accordingly, while the main dial is being repaired, the watch owner still utilizes the watch as needed to achieve daily goals. Further, any of the mechanisms 15, 16, 17 and 18 is capable of being removed an replaced with a different mechanism and dial.

The present invention may be embodied in other specific forms without departing from its spirit or essential characteristics. The described embodiments are to be considered in all respects only as illustrative and not as restrictive. The scope of the invention is, therefore, indicated by the appended claims and their combination in whole or in part rather than by the foregoing description. All changes that come within the meaning and range of equivalency of the claims are to be embraced within their scope.

1) A watch mechanism comprising:
a plurality of movements; each movement having a face, each movement being capable of operating independently of each other movement, each movement being capable of removal from the watch independently of each other movement, and each movement being capable of operation following the removal of one or more other movements.

2) The watch of claim 1 wherein each plurality of movements comprises a respective power source being independent of the power source of any other movement.

3) The watch of claim 2 wherein the movements comprise a main movement and a plurality of subordinate movements, where the main movement being larger than the subordinate movements.

4) The watch of claim 3 wherein the main movement comprising one or more of a lunar display and a chronograph.

5) The watch of claim 3 wherein the plurality of subordinate movements comprise three subordinate movements.

6) The watch of claim 5 wherein the main movement being located on the bottom right corner of the watch and the three subordinate movements each being located on a respective different quadrant of the watch face and a different quadrant than the main movement.

7) The watch of claim 6 wherein each movement being analogue and each having a dial, a crown, and gear stem.

8) The watch of claim 7 wherein each stem projects perpendicularly from each respective movement.

9) The watch of claim 8 having a center plate, the center plate having four openings, each opening capable of housing a respective movement, wherein each movement being restrained in each opening by either frictional engagement or snaps.

10) The watch of claim 9 wherein each movement being either circular or square.

11) The watch of claim 10 comprising a watch case, the case being curved.

12) The watch of claim 9 wherein each movement is capable of being removed and replaced with a new movement.
